(19) United States
(12) Patent Application Publication
(10) Pub. No.: US 2021/0039917 A1
(43) Pub. Date: Feb. 11, 2021

(54) ELEVATOR CONTROL

(71) Applicant: BEIJING SANKUAI ONLINE TECHNOLOGY CO., LTD., Beijing (CN)

(72) Inventors: Di ZHANG, Beijing (CN); Ka GUAN, Beijing (CN)

(21) Appl. No.: 17/080,156

(22) Filed: Oct. 26, 2020

Related U.S. Application Data
(63) Continuation of application No. PCT/CN2018/121588, filed on Dec. 17, 2018.

(30) Foreign Application Priority Data
Apr. 27, 2018 (CN) 201810392244.7

(51) Int. Cl. B66B 1/34; B66B 1/46

(52) U.S. Cl. CPC B66B 1/3461; B66B 1/468; B66B 2201/4653; B66B 2201/4638; B66B 2201/214

(57) ABSTRACT

An elevator control method, apparatus, and system, and an electronic device. The elevator control method includes: receiving a notification message, the notification message carrying a target moment, and the target moment being a moment at which an elevator door opens, or being a preset moment before the elevator door opens; performing a preset operation for instructing a driverless smart device to enter/exit an elevator in a case of determining, based on the target moment carried by the notification message, that a preset condition is met; and instructing an elevator control device to call the elevator in a case of determining, based on the target moment carried by the notification message, that the preset condition is not met.

### CROSS-REFERENCE TO RELATED APPLICATIONS

This application claims priority to Chinese Patent No. 2018103922447 entitled “ELEVATOR CONTROL METHOD, APPARATUS, AND SYSTEM, AND ELECTRONIC DEVICE” filed on Apr. 27, 2018, the entire content of which is incorporated herein by reference.

### TECHNICAL FIELD

This application relates to the field of network technologies, and in particular, to an elevator control method, apparatus, and system, a readable storage medium, and an electronic device.

### BACKGROUND

At present, when using an elevator, a driverless smart device may generally call the elevator through a network. After the elevator arrives at a target floor, the driverless smart device can learn of, through the network, a message that the elevator arrives, and automatically enter/exit the elevator. However, communication of the network may sometimes fail, to result in a communication delay. Consequently, the elevator has begun to close when the driverless smart device just receives the message that the elevator arrives. In this case, if the driverless smart device continues to perform the operation of entering/exiting the elevator, damage to the elevator or the driverless smart device may be caused, and the safety of using the elevator is reduced.

### SUMMARY

This application provides an elevator control method, apparatus, and system, and an electronic device.

According to a first aspect of this application, an elevator control method is provided, including: receiving a notification message, the notification message carrying a target moment, and the target moment being a moment at which an elevator door opens, or being a preset moment before the elevator door opens; performing a preset operation for instructing a driverless smart device to enter/exit an elevator in a case of determining, based on the target moment carried by the notification message, that a preset condition is met; and instructing an elevator control device to call the elevator in a case of determining, based on the target moment carried by the notification message, that the preset condition is not met.

According to a second aspect of this application, an elevator control apparatus is provided, including: a receiving module, configured to receive a notification message, the notification message carrying a target moment, and the target moment being a moment at which an elevator door opens, or being a preset moment before the elevator door opens; a first execution module, configured to perform a preset operation for instructing a driverless smart device to enter/exit an elevator in a case of determining, based on the target moment carried by the notification message, that a preset condition is met; and a second execution module, configured to instruct an elevator control device to call the elevator in a case of determining, based on the target moment carried by the notification message, that the preset condition is not met.

According to a third aspect of this application, an elevator control system is provided, including: an elevator control device, a server, and a driverless smart device. A communication connection is established between the elevator control device and the server, and a communication connection is established between the server and the driverless smart device. The elevator control device is configured to call an elevator, record a target moment, and transmit a first message carrying the target moment to the server, where the target moment is a moment at which an elevator door opens, or a preset moment before the elevator door opens. The server is configured to receive the first message, and transmit a second message carrying the target moment to the driverless smart device. The driverless smart device is configured to receive the second message. The driverless smart device performs an operation of entering/exiting the elevator in a case of determining, based on the target moment carried by the second message, that a first condition is met. The driverless smart device instructs the elevator control device to call the elevator again through the server in a case of determining, based on the target moment carried by the second message, that the first condition is not met.

According to a fourth aspect of this application, a nonvolatile computer-readable storage medium is provided, storing a computer program, the computer program, when executed by a processor, implementing any method according to the first aspect.

According to a fifth aspect of this application, an electronic device is provided, including a memory, a processor, and a computer program stored on the memory and executable on the processor, the processor, when executing the program, implementing any method according to the first aspect.

The elevator control system provided in this application includes an elevator control device, a server, and a driverless smart device. A communication connection is established between the elevator control device and the server, and a communication connection is established between the server and the driverless smart device. The elevator control device is configured to call an elevator, record a target moment, and transmit a first message carrying the target moment to the server. The target moment is a moment at which the elevator door opens, or a preset moment before the elevator door opens. The server is configured to receive the first message, and transmit a second message carrying the target moment to the driverless smart device. The driverless smart device is configured to receive the second message. The driverless smart device performs an operation of entering/exiting the elevator in a case of determining, based on the target moment carried by the second message, that a first condition is met. The driverless smart device instructs the elevator control device to call the elevator again through the server in a case of determining, based on the target moment carried by the second message, that the first condition is not met. The elevator control device in this embodiment can record the target moment, and the driverless smart device can obtain the target moment recorded by the elevator control device through the server, and perform the operation of entering/exiting the elevator in a case of determining, based on the target moment, that the first condition is met; and the driverless smart device instructs the elevator control device to call the elevator again through the server in a case that the first condition is not met. Therefore, damage to the elevator or the driverless smart device caused by a communication delay can be avoided.

It is to be understood that the foregoing general descriptions and the following detailed descriptions are merely exemplary and explanatory, and are not intended to limit this application.

### BRIEF DESCRIPTION OF THE DRAWINGS

Accompanying drawings herein are incorporated into the specification and constitute a part of this specification, show embodiments that conform to this application, and are used for describing the principle of this application together with this specification.

FIG. 1 is a schematic diagram of an exemplary system architecture to which an embodiment of this application is applied.

FIG. 2 is a block diagram of an elevator control system according to an exemplary embodiment of this application.

FIG. 3 is a flowchart of an elevator control method according to an exemplary embodiment of this application.

FIG. 4 is a schematic diagram of another elevator control method according to an exemplary embodiment of this application.

FIG. 5 is a block diagram of an elevator control apparatus according to an exemplary embodiment of this application.

FIG. 6 is a block diagram of another elevator control apparatus according to an exemplary embodiment of this application.

FIG. 7 is a schematic structural diagram of an electronic device according to an exemplary embodiment of this application.

FIG. 8 Schematically shows a block diagram of a computing processing device for implementing a method according to the disclosure;

FIG. 9 schematically shows a storage unit for holding or carrying program codes for implementing a method according to the disclosure.

### DETAILED DESCRIPTION OF THE EMBODIMENTS

The technical solutions in the embodiments of this application are clearly described in the following with reference to the accompanying drawings in the embodiments of this application. Apparently, the described embodiments are merely some embodiments of this application rather than all of the embodiments. All other embodiments obtained by a person of ordinary skill in the art based on the embodiments of this application without creative efforts shall fall within the protection scope of this application.

Exemplary embodiments are described in detail herein, and examples of the exemplary embodiments are shown in the accompanying drawings. When the following descriptions relate to the accompanying drawings, unless indicated otherwise, same numbers in different accompanying drawings represent same or similar elements. The following implementations described in the following exemplary embodiments do not represent all implementations that are consistent with this application. On the contrary, the implementations are merely examples of apparatuses and methods consistent with those described in detail in the appended claims and some aspects of this application.

The terms used in this application are merely used for illustrating specific embodiments, and are not intended to limit this application. The terms “a”, “said”, and “the” of singular forms used in this application and the appended claims are also intended to include plural forms, unless otherwise specified in the context clearly. It is also to be understood that the term “and/or” used herein refers to and includes any or all possible combinations of one or more associated listed items.

It is to be understood that although terms such as first, second, and third may be used in this application to describe various information, the information is not to be limited to such terms. Such terms are merely used to distinguish the same type of information from each other. For example, without departing from the scope of this application, first information may also be referred to as second information, and similarly, second information may also be referred to as first information. Depending on the context, the word “if” as used herein can be interpreted as “while” or “when” or “in response to determining”, both of which are used to indicate judgment conditions.

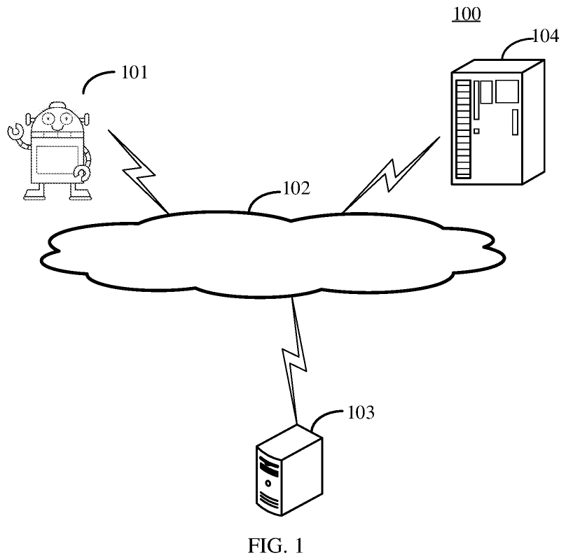

FIG. 1 is a schematic diagram of an exemplary system architecture to which an embodiment of this application is applied.

As shown in FIG. 1, a system architecture 100 may include a driverless smart device 101, a network 102, a server 103, and an elevator control device 104. It is to be understood that quantities or types of the driverless smart device, the network, the server, and the elevator control device in FIG. 1 are only schematic. There may be any quantities or types of driverless smart devices, networks, servers, and elevator control devices according to implementation requirements.

The network 102 is configured to provide a medium of a communication link between the driverless smart device 101 and the server 103, and provide a medium of a communication link between the server 103 and the elevator control device 104. The network 102 may include various connection types, such as a wired communication link, a wireless communication link, or a fiber optic cable.

The driverless smart device 101 may communicate with the server 103 through the network 102, and the elevator control device 104 may also communicate with the server 103 through the network 102. The driverless smart device 101 and the elevator control device 104 may interact through the server 103 to receive or transmit a request or information. The driverless smart device 101 may include, but is not limited to a smart robot, an unmanned ground vehicle, an unmanned aerial vehicle, and the like. The elevator control device 104 may be used for controlling an elevator and detecting a status of the elevator. For example, the elevator control device 104 may be used for calling the elevator (for example, internal call or external call), or detecting a current operating status of the elevator and a floor the elevator is on.

The server 103 may provide various services. The server 103 may process, such as store and analyze, received data, and may further transmit a control command or request to the driverless smart device 101 or the elevator control device 104. The server 103 may provide a service in response to a service request. It is understood that a server may provide one or more services, and the same service may alternatively be provided by a plurality of servers.

This application is described in detail below with reference to specific embodiments.

As shown in FIG. 2, FIG. 2 is a block diagram of an elevator control system according to an exemplary embodiment. The system may include: an elevator control device 201, a server 202, and a driverless smart device 203. A communication connection is established between the elevator control device 201 and the server 202, and a communication connection is established between the server 202 and the driverless smart device 203.

The elevator control device 201 is configured to call an elevator, record a target moment, and transmit a first message carrying the target moment to the server 202. The target moment is a moment at which the elevator door opens, or a preset moment before the elevator door opens.

In this embodiment, the elevator control device 201 may call the elevator in response to an elevator calling request. The driverless smart device 203 may instruct the server 202 to transmit the elevator calling request to the elevator control device 201. Calling the elevator may include instructing the elevator to stop at a target floor.

In this embodiment, after calling the elevator, the elevator control device 201 may further monitor the status of the elevator, to determine a floor that the elevator arrives at. When the elevator stops at the target floor, the elevator control device 201 may record the target moment, and transmit the first message carrying the target moment to the server 202, to notify the server 202 that “the elevator is currently stopping at the target floor”. The target moment may be a moment at which the elevator door opens or a preset moment before the elevator door opens after the elevator arrives at the target floor. It should be noted that the elevator door may be opened for the first time or opened again. For example, the target moment may be a moment at which the elevator arrives at the target floor, or may be a moment at which the elevator door starts to close after opening (that is, a preset moment before the elevator door opens again). It is understood that the preset moment before the elevator door opens may be any moment. This is not limited in this application.

The server 202 is configured to receive the first message, and transmit a second message carrying the target moment to the driverless smart device 203.

In this embodiment, the server 202 may receive the first message transmitted by the elevator control device 201, and in response to the first message, transmit the second message carrying the target moment to the driverless smart device 203, to notify the driverless smart device 203 that “the elevator is currently stopping at the target floor”.

In an implementation, the server 202 may directly transmit the second message carrying the target moment to the driverless smart device 203 in response to the first message.

In another implementation, the server 202, in response to the first message, may further first determine whether a preset condition is met, and when the preset condition is met, the server 202 transmits the second message carrying the target moment to the driverless smart device 203. When the preset condition is not met, the server 202 is prohibited from transmitting the second message to the driverless smart device 203.

The driverless smart device 203 is configured to receive the second message, and perform an operation of entering/exiting the elevator in a case of determining, based on the target moment carried by the second message, that a first condition is met; and instruct the elevator control device 201 to call the elevator again through the server 202 in a case of determining, based on the target moment carried by the second message, that the first condition is not met.

In this embodiment, the driverless smart device 203 may receive the second message transmitted by the server 202, obtain the target moment from the second message, and determine, based on the target moment, whether the first condition is met. The first condition is related to a timing of the driverless smart device 203 entering/exiting the elevator. When the first condition is met, it indicates that the timing of the driverless smart device 203 entering/exiting the elevator is appropriate. When the first condition is not met, it indicates that the timing of the driverless smart device 203 entering/exiting the elevator is inappropriate, for example, too early or too late. Therefore, the driverless smart device 203 may perform the operation of entering/exiting the elevator when the first condition is met, and may be prohibited from performing the operation of entering/exiting the elevator when the first condition is not met, and transmit indication information to the server 202 to instruct the server 202 to transmit an elevator calling request to the elevator control device 201, to control the elevator control device 201 to call the elevator again. It should be noted that the first condition may be any condition. Specific content of the first condition is not limited in this application.

The elevator control system provided in the foregoing embodiment of this application includes an elevator control device, a server, and a driverless smart device. A communication connection is established between the elevator control device and the server, and a communication connection is established between the server and the driverless smart device. The elevator control device is configured to call an elevator, record a target moment, and transmit a first message carrying the target moment to the server. The target moment is a moment at which the elevator door opens, or a preset moment before the elevator door opens. The server is configured to receive the first message, and transmit a second message carrying the target moment to the driverless smart device. The driverless smart device is configured to receive the second message, and perform an operation of entering/exiting the elevator in a case of determining, based on the target moment carried by the second message, that a first condition is met. The driverless smart device instructs the elevator control device to call the elevator again through the server in a case of determining, based on the target moment carried by the second message, that the first condition is not met. The elevator control device in this embodiment can record the target moment, and the driverless smart device can obtain the target moment recorded by the elevator control device through the server, and perform the operation of entering/exiting the elevator in a case of determining, based on the target moment, that the first condition is met; and the driverless smart device instructs the elevator control device to call the elevator again through the server in a case that the first condition is not met. Therefore, damage to the elevator or the driverless smart device caused by a communication delay can be effectively avoided.

In some implementations, the server 202 is further configured to determine to perform an operation of transmitting the second message to the driverless smart device 203 in a case of determining, based on the target moment carried by the first message, that a second condition is met. The server 202 instructs the elevator control device 201 to call the elevator again in a case of determining, based on the target moment carried by the first message, that the second condition is not met.

In this embodiment, the server 202 may, in response to the first message, obtain the target moment from the first message and determine, based on the target moment, whether the second condition is met. The second condition is related to a timing of the driverless smart device 203 entering/exiting the elevator. When the second condition is met, it indicates that the timing of the driverless smart device 203 entering/exiting the elevator may be appropriate. When the second condition is not met, it indicates that the timing of the driverless smart device 203 entering/exiting the elevator is too late. Therefore, when the second condition is met, the server 202 needs to perform the operation of transmitting the second message to the driverless smart device 203, and further transmit the second message to the driverless smart device 203. When the second condition is not met, the server 202 transmits the indication information to the elevator control device 201, to instruct the elevator control device 201 to call the elevator again.

The elevator control device 201 in this embodiment can record the target moment, and the server 202 can obtain the target moment recorded by the elevator control device 201, and perform the operation of transmitting the second message to the driverless smart device 203 in a case of determining, based on the target moment, that the second condition is met; and when the second condition is not met, the server 202 instructs the elevator control device 201 to call the elevator again. Therefore, this embodiment is helpful in avoiding damage to the elevator or the driverless smart device 203 caused by a communication delay.

In some implementations, the driverless smart device 203 is further configured to determine that the first condition is met in a case of determining that a duration between a moment at which the second message is received and the target moment is less than a preset duration. The driverless smart device 203 determines that the first condition is not met in a case of determining that the duration between the moment at which the second message is received and the target moment is greater than or equal to the preset duration.

In this embodiment, the driverless smart device 203 may determine whether the first condition is met in the following manner: by calculating a duration from the target moment to the moment at which the second message is received, and comparing the duration with the preset duration. If the duration is less than the preset duration, it may be determined that the first condition is met. If the duration is greater than or equal to the preset duration, it may be determined that the first condition is not met. The preset duration may be an empirical value, and the preset duration is not less than a difference between a duration of the elevator door remaining open and a duration required by the driverless smart device 203 to enter/exit the elevator.

The driverless smart device 203 determines that the first condition is met in a case of determining that the duration between the moment at which the second message is received and the target moment is less than the preset duration. The driverless smart device 203 determines that the first condition is not met in a case of determining that the duration between the moment at which the second message is received and the target moment is greater than or equal to the preset duration. Therefore, it can be determined more precisely whether the timing of the driverless smart device 201 entering/exiting the elevator is appropriate.

In some other implementations, the server 202 is further configured to determine that the second condition is met in a case of determining that a duration between a moment at which the first message is received and the target moment is less than a preset duration. The server 202 determines that the second condition is not met in a case of determining that the duration between the moment at which the first message is received and the target moment is greater than or equal to the preset duration.

In this embodiment, the server 202 may determine whether the second condition is met in the following manner: by calculating a duration from the target moment to the moment at which the first message is received, and comparing the duration with the preset duration. If the duration is less than the preset duration, it may be determined that the second condition is met. If the duration is greater than or equal to the preset duration, it may be determined that the second condition is not met. The preset duration may be an empirical value, and the preset duration is not less than a difference between a duration of the elevator door remaining open and a duration required by the driverless smart device 203 to enter/exit the elevator.

The server 202 determines that the second condition is met in a case of determining that the duration between the moment at which the first message is received and the target moment is less than the preset duration. The server 202 determines that the second condition is not met in a case of determining that the duration between the moment at which the first message is received and the target moment is greater than or equal to the preset duration. Therefore, it can be determined more precisely whether the timing of the driverless smart device 203 entering/exiting the elevator may be appropriate.

The solution of this application is described schematically below with reference to a complete application example of an elevator control system.

An application scenario may be: the system includes an elevator control device A, a server B and a robot (driverless smart device) C, a communication connection is established between the elevator control device A and the server B, and a communication connection is established between the server B and the robot C. The robot C is outside an elevator on an N^{th} floor and is ready to take the elevator.

First, the robot C transmits an elevator calling request to the elevator control device A through the server B, and the elevator control device A calls the elevator in response to the elevator calling request for the elevator to run to the N^{th} floor. In addition, when the elevator arrives at the N^{th} floor, the elevator control device A records a moment at which the elevator arrives at the N^{th} floor as a target moment, and transmits a first message to the server B to notify the server B that the elevator has arrived. The first message carries the target moment.

Then the server B, in response to the first message, obtains the target moment from the first message and calculates a duration between a moment at which the first message is received and the target moment. The server B compares the duration with the preset duration. If there is a relatively large delay in the network, a value of the duration may be relatively large. When the duration is greater than or equal to the preset duration, it indicates that the robot C has no time to enter the elevator. In this case, the server B transmits indication information to the elevator control device A, to instruct the elevator control device A to call the elevator again. If there is no delay in the network or the delay is relatively small, the value of the duration may be relatively small. When the duration is less than the preset duration, it indicates that the robot C still has time to enter the elevator. In this case, the server B transmits a second message carrying the target moment to the robot C, to notify the robot C that the elevator has arrived.

Then the robot C, in response to the second message, obtains the target moment from the second message and calculates a duration between a moment at which the second message is received and the target moment. The duration is compared with the preset duration. Similarly, when the duration is greater than or equal to the preset duration, it indicates that the robot C has no time to enter the elevator. In this case, the robot C transmits indication information to the elevator control device A through the server B, to instruct the elevator control device A to call the elevator again. When the duration is less than the preset duration, it indicates that the robot C still has time to enter the elevator. In this case, the robot C automatically performs an operation of entering the elevator.

It can be seen that by applying the above solution, the elevator control device A can record the target moment, both the server B and the robot C can determine whether the robot C still has time to enter the elevator according to the target moment, and the robot C performs the operation of entering the elevator when the robot C has time to enter the elevator; and when the robot C has no time to enter the elevator, the robot C instructs the elevator control device A to call the elevator again. Therefore, damage to the elevator or the robot C (the driverless smart device) caused by a communication delay can be avoided.

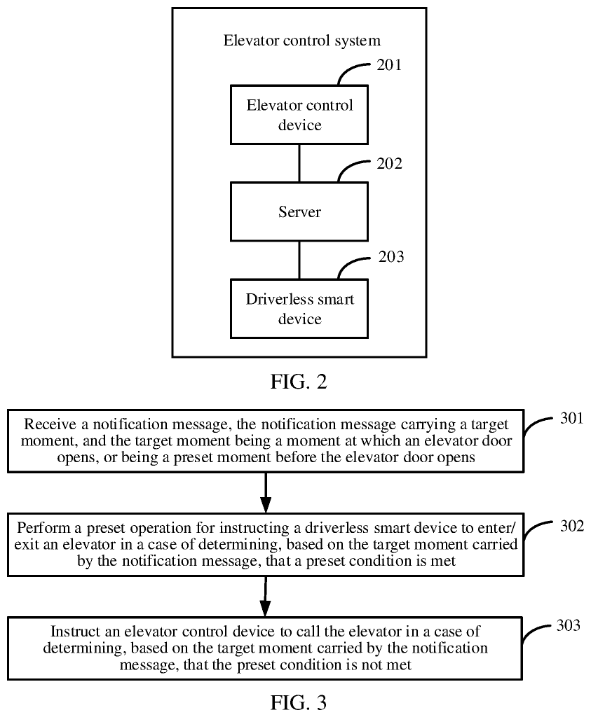

As shown in FIG. 3, FIG. 3 is a flowchart of an elevator control method according to an exemplary embodiment. The method may be applied to a driverless smart device, or may be applied to a server. A person skilled in the art may understand that the driverless smart device may include, but is not limited to a smart robot, an unmanned ground vehicle, an unmanned aerial vehicle, and the like. The method includes the following steps:

Step 301: Receive a notification message, the notification message carrying a target moment, and the target moment being a moment at which an elevator door opens, or being a preset moment before the elevator door opens.

In this embodiment, if an execution body is the server, the notification message may be transmitted by an elevator control device. When the execution body is the driverless smart device, the notification message may be transmitted by the server. The notification message may be used for notifying the server or the driverless smart device that an elevator is currently stopping at a target floor.

In this embodiment, the target moment may be a moment at which the elevator door opens or a preset moment before the elevator door opens after the elevator arrives at the target floor. It should be noted that the elevator door may be opened for the first time or opened again. For example, the target moment may be a moment at which the elevator arrives at the target floor, or may be a moment at which the elevator door starts to close after opening (that is, a preset moment before the elevator door opens again). It is understood that the preset moment before the elevator door opens may be any moment. This is not limited in this application.

Step 302: Perform a preset operation for instructing a driverless smart device to enter/exit an elevator in a case of determining, based on the target moment carried by the notification message, that a preset condition is met.

In this embodiment, when the execution body is the server, the server may transmit a control command to the driverless smart device, to instruct the driverless smart device to enter/exit the elevator in a case of determining, based on the target moment carried by the notification message, that the preset condition is met. When the execution body is the driverless smart device, the driverless smart device may directly perform an operation of entering/exiting the elevator in a case of determining, based on the target moment carried by the notification message, that the preset condition is met. Therefore, the foregoing preset operation may be any operation for instructing the driverless smart device to enter/exit the elevator. Specific content of the preset operation is not limited in this application.

Step 303: Instruct an elevator control device to call the elevator in a case of determining, based on the target moment carried by the notification message, that the preset condition is not met.

In this embodiment, when the execution body is the server, the server may transmit a command to the elevator control device, to instruct the elevator control device to call the elevator in a case of determining, based on the target moment carried by the notification message, that the preset condition is not met. When the execution body is the driverless smart device, the driverless smart device may transmit a command to the elevator control device through the server, to instruct the elevator control device to call the elevator in a case of determining, based on the target moment carried by the notification message, that the preset condition is not met.

According to the elevator control method in this embodiment of this application, whether the preset condition is met is determined based on the target moment carried by the notification message by receiving the notification message, the notification message carrying the target moment, and the target moment being the moment at which the elevator door opens, or being the preset moment before the elevator door opens. The preset operation for instructing the driverless smart device to enter/exit the elevator is performed in a case of determining, based on the target moment carried by the notification message, that the preset condition is met. The elevator control device is instructed to call the elevator in a case of determining, based on the target moment carried by the notification message, that the preset condition is not met. Therefore, damage to the elevator or the driverless smart device caused by a communication delay can be avoided.

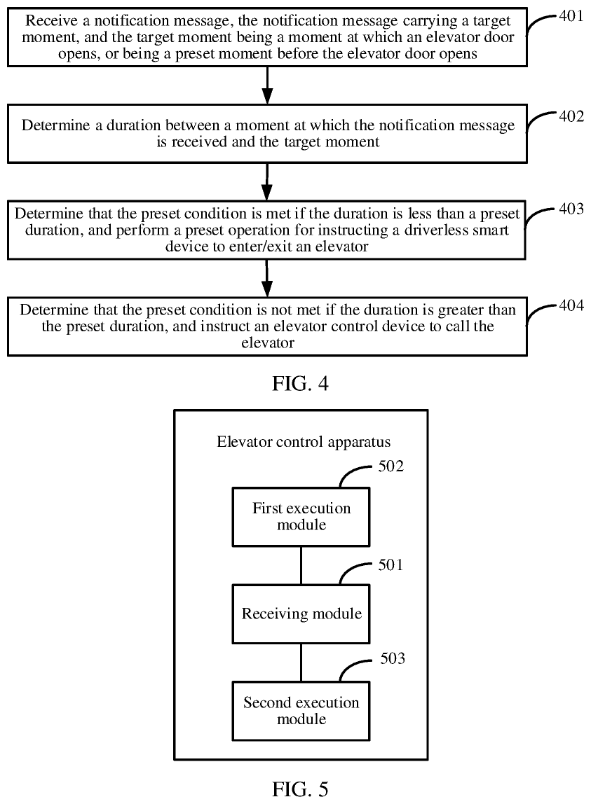

As shown in FIG. 4, FIG. 4 is a flowchart of another elevator control method according to an exemplary embodiment. This embodiment describes a process of determining that a preset condition is met. The method may be applied to a driverless smart device, or may be applied to a server, and include the following steps:

Step 401: Receive a notification message, the notification message carrying a target moment, and the target moment being a moment at which an elevator door opens, or being a preset moment before the elevator door opens.

Step 402: Determine a duration between a moment at which the notification message is received and the target moment.

Step 403: Determine that a preset condition is met if the duration is less than a preset duration, and perform a preset operation for instructing a driverless smart device to enter/exit an elevator.

Step 404: Determine that the preset condition is not met if the duration is greater than the preset duration, and instruct an elevator control device to call the elevator.

It should be noted that the same steps as those in the embodiment in FIG. 3 are not be repeated in the above embodiment in FIG. 4, and for related content, reference can be made to the embodiment in FIG. 3.

According to the elevator control method provided in the foregoing embodiment of this application, the duration between the moment at which the notification message is received and the target moment is determined by receiving the notification message, the notification message carrying the target moment, and the target moment being the moment at which the elevator door opens, or being the preset moment before the elevator door opens. It is determined that the preset condition is met if the duration is less than the preset duration, and the preset operation for instructing the driverless smart device to enter/exit the elevator is performed. It is determined that the preset condition is not met if the duration is greater than the preset duration, and the elevator control device is instructed to call the elevator. Therefore, it can be determined more precisely whether the timing of the driverless smart device entering/exiting the elevator is appropriate, damage to the elevator or the driverless smart device caused by a communication delay can be further avoided.

In some implementations, referring to the foregoing embodiment, when the execution body is the driverless smart device, a received notification message may be further transmitted when the server determines, based on the target moment, that the preset condition is met. It may be determined that the preset condition is met in a case that the duration between a moment at which the server receives a message that the elevator has arrived and the target moment is less than the preset duration.

It should be noted that although the operations of the method in this application are described in a specific order in the foregoing embodiment, this does not require or imply that the operations have to be performed in the specific order, or all the operations shown have to be performed to achieve an expected result. Conversely, the order of execution of the steps described in the flowchart can be changed. Additionally or alternatively, some steps may be omitted, a plurality of steps may be combined into one step for execution, and/or one step may be decomposed into a plurality of steps for execution.

Corresponding to the foregoing embodiment of the elevator control method, this application further provides an embodiment of an elevator control apparatus.

As shown in FIG. 5, FIG. 5 is a block diagram of an elevator control apparatus according to an exemplary embodiment of this application. The apparatus may include: a receiving module 501, a first execution module 502, and a second execution module 503.

The receiving module 501 is configured to receive a notification message, the notification message carrying a target moment, and the target moment being a moment at which an elevator door opens, or being a preset moment before the elevator door opens.

The first execution module 502 is configured to perform a preset operation for instructing a driverless smart device to enter/exit an elevator in a case of determining, based on the target moment carried by the notification message, that a preset condition is met.

The second execution module 503 is configured to instruct an elevator control device to call the elevator in a case of determining, based on the target moment carried by the notification message, that the preset condition is not met.

As shown in FIG. 6, FIG. 6 is a block diagram of another elevator control apparatus according to an exemplary embodiment of this application. This embodiment is based on the foregoing embodiment shown in FIG. 5. The apparatus may further include: a first determining module 504, and a second determining module 505.

The first determining module 504 is configured to determine a duration between a moment at which the notification message is received and the target moment.

The second determining module 505 is configured to determine, in a case that the duration is less than a preset duration, that the preset condition is met, and determine, in a case that the duration is greater than or equal to the preset duration, that the preset condition is not met.

In some implementations, the notification message is transmitted in a case of determining, based on the target moment, that the preset condition is met.

It is to be understood that the foregoing elevator control apparatus may be pre-disposed in the driverless smart device or the server, or may be loaded into the driverless smart device or the server in a manner of downloading or the like. Corresponding modules in the foregoing elevator control apparatus may cooperate with modules in the driverless smart device or the server to implement the elevator control solution.

The apparatus embodiment basically corresponds to the method embodiment, and therefore for related parts, reference may be made to partial descriptions in the method embodiment. The described apparatus embodiment is merely an example. The units described as separate parts may or may not be physically separate, and parts displayed as units may or may not be physical units, may be located in one position, or may be distributed on a plurality of network units. The objective of the solution of this application may be implemented by selecting some or all of the modules according to actual needs. A person of ordinary skill in the art may understand and implement the embodiments of this application without creative efforts.

The embodiments of this application further provide a nonvolatile computer-readable storage medium, storing a computer program. The computer program may be used for performing the foregoing elevator control method provided in either embodiment in FIG. 3 and FIG. 4.

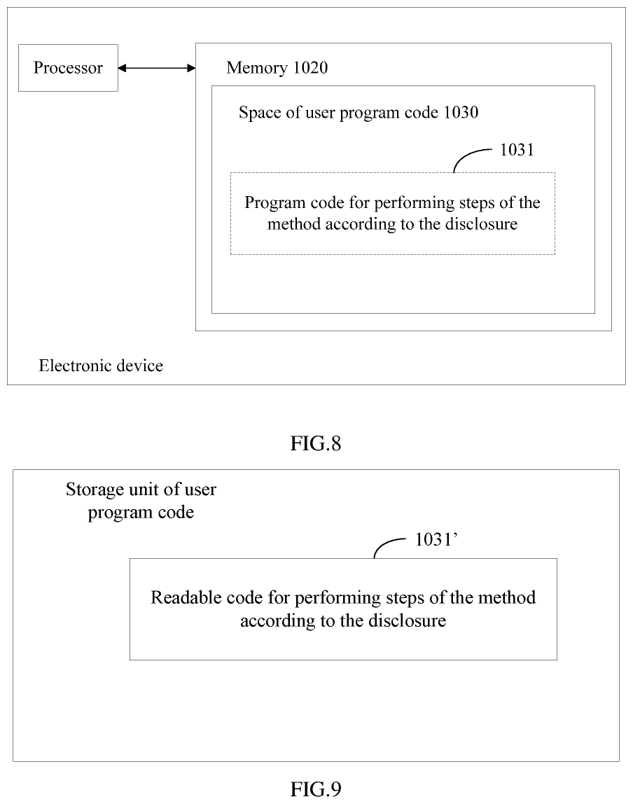

For example, FIG. 8 shows an electronic device in which the method according to the disclosure may be implemented. The electronic device conventionally includes a processor 1010 and a computer program product or computer-readable medium in the form of a memory 1020. The memory 1020 may be an electronic memory such as a flash memory, an EEPROM (Electrically Erasable Programmable Read Only Memory), an EPROM, a hard disk, or a ROM. The memory 1020 has a storage space 1030 for program codes 1031 for performing any of the method steps in the above methods. For example, the storage space 1030 for program codes may include respective program codes 1031 for implementing the various steps in the above methods, respectively. The program codes may be read from or written to one or more computer program products. These computer program products include a program code carrier such as a hard disk, a compact disk (CD), a memory card or a floppy disk. Such a computer program product is typically a portable or fixed storage unit as described with reference to FIG. 9. The storage unit may have storage segments, storage space, etc., arranged similarly to the memory 1020 in the computing processing device of FIG. 8. The program codes may be compressed, for example, in a suitable form. Typically, the storage unit includes computer-readable codes 1031′, i.e., codes readable by a processor, such as 1010, for example, which, when executed by an electronic device, causes the electronic device to perform the various steps of the methods described above.

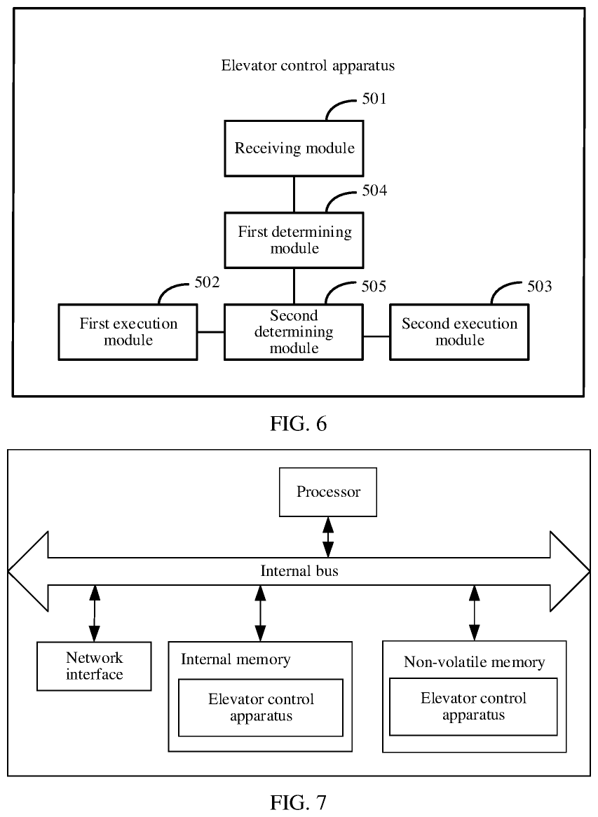

Corresponding to the foregoing elevator control method, the embodiments of this application further provide a schematic structural diagram of an electronic device according to an exemplary embodiment of this application as shown in FIG. 7. Referring to FIG. 7, at a hardware level, the electronic device includes a processor, an internal bus, a network interface, an internal memory, and a non-volatile memory, and may certainly further include hardware required for other services. The processor reads a corresponding computer program from the non-volatile memory to the internal memory and then runs the computer program to form an elevator control apparatus at a logical level. Certainly, in addition to a software implementation, this application does not exclude another implementation, such as a logic device, or a combination of software and hardware. In other words, the execution body of the following processing flow is not limited to each logic unit, or may be hardware or the logic device.

After considering the specification and practicing the present disclosure, a person skilled in the art would easily conceive of other implementations of this application. This application is intended to cover any variation, use, or adaptive change of this application. These variations, uses, or adaptive changes follow the general principles of this application and include common general knowledge or common technical means in the art that are not disclosed in this application. The specification and the embodiments are considered as merely exemplary and the real scope and spirit of this application are pointed out in the following claims.

It is to be understood that this application is not limited to the precise structures described above and shown in the accompanying drawings and various modifications and changes can be made without departing from the scope of this application. The scope of this application is limited only by the appended claims.

1. An elevator control method, comprising:
receiving a notification message, the notification message carrying a target moment, and the target moment being a moment at which an elevator door opens, or being a preset moment before the elevator door opens;
performing a preset operation for instructing a driverless smart device to enter/exit an elevator in a case of determining, based on the target moment carried by the notification message, that a preset condition is met; and
instructing an elevator control device to call the elevator in a case of determining, based on the target moment carried by the notification message, that the preset condition is not met.

2. The method according to claim 1, further comprising:
determining a duration between a moment at which the notification message is received and the target moment;
determining, in a case that the duration is less than a preset duration, that the preset condition is met; and
determining, in a case that the duration is greater than or equal to the preset duration, that the preset condition is not met.

3. An elevator control system, comprising:
an elevator control device;
a driverless smart device; and
a server, a communication connection being established between the elevator control device and the server, and a communication connection being established between the server and the driverless smart device;
the elevator control device being configured to call an elevator, record a target moment, and transmit a first message carrying the target moment to the server; and the target moment being a moment at which an elevator door opens, or being a preset moment before the elevator door opens;
the server being configured to receive the first message, and transmit a second message carrying the target moment to the driverless smart device; and
the driverless smart device being configured to receive the second message, and perform an operation of entering/exiting the elevator in a case of determining, based on the target moment carried by the second message, that a first condition is met; and instruct the elevator control device to call the elevator again through the server in a case of determining, based on the target moment carried by the second message, that the first condition is not met.

4. The system according to claim 3, wherein the server is further configured to:
determine to perform an operation of transmitting the second message to the driverless smart device in a case of determining, based on the target moment carried by the first message, that a second condition is met; and
instruct the elevator control device to call the elevator again in a case of determining, based on the target moment carried by the first message, that the second condition is not met.

5. The system according to claim 3, wherein the driverless smart device is further configured to:
determine that the first condition is met in a case of determining that a duration between a moment at which the second message is received and the target moment is less than a preset duration; and
determine that the first condition is not met in a case of determining that the duration between the moment at which the second message is received and the target moment is greater than or equal to the preset duration.

6. The system according to claim 4, wherein the server is further configured to:
determine that the second condition is met in a case of determining that a duration between a moment at which the first message is received and the target moment is less than a preset duration; and
determine that the second condition is not met in a case of determining that the duration between the moment at which the first message is received and the target moment is greater than or equal to the preset duration.

7. A nonvolatile computer-readable storage medium, storing a computer program, the computer program, when executed by a processor, implementing the method according to claim 1.

8. An electronic device, comprising a memory, a processor, and a computer program stored on the memory and executable on the processor, the processor, when executing the program, performing the following operations, comprising:
receiving a notification message, the notification message carrying a target moment, and the target moment being a moment at which an elevator door opens, or being a preset moment before the elevator door opens;
performing a preset operation for instructing a driverless smart device to enter/exit an elevator in a case of determining, based on the target moment carried by the notification message, that a preset condition is met; and
instructing an elevator control device to call the elevator in a case of determining, based on the target moment carried by the notification message, that the preset condition is not met.

9. The electronic device according to claim 8, further comprising:
determining a duration between a moment at which the notification message is received and the target moment;
determining, in a case that the duration is less than a preset duration, that the preset condition is met; and
determining, in a case that the duration is greater than or equal to the preset duration, that the preset condition is not met.
